(19) United States
(12) Patent Application Publication
(10) Pub. No.: US 2004/0037222 A1
(43) Pub. Date: Feb. 26, 2004

(54) Method of controlling operation mode of hybrid access terminal supporting voice service and packet data service

(76) Inventors: Kyung-Jin Kim, Seoul (KR); Tae-Won Kim, Anyang-shi (KR)

Correspondence Address: Peter L. Kendall, Roylance, Abrams, Berdo & Goodman, L.L.P., Suite 600, 1300 19th Street, N.W., Washington, DC, 20036, US

(21) Appl. No.: 10/606,806

(22) Filed: Jun. 27, 2003

(30) Foreign Application Priority Data
Jun. 29, 2002 (KR) 2002-37478

(51) Int. Cl. H04L 12/66; H04L 1/00

(52) U.S. Cl. 370/229; 370/352

(57) ABSTRACT

Disclosed is a method of controlling the operation mode of a HAT capable of communicating in a first communication system that supports voice service and low-speed data service and in a second communication system that supports high-speed data service. The HAT monitors both the first and second communication systems in a hybrid operation mode by the HAT. Upon receipt of a message ordering mode transition from the second communication system, the HAT transitions from the hybrid operation mode to a data-only operation mode, discontinues monitoring the first communication system, and monitors only the second communication system. The HAT transmits/receives a signaling message of the first communication system wrapped in a signaling message format of the second communication system in the data-only operation mode.

### PRIORITY

This application claims priority under 35 U.S.C. § 119 to an application entitled “Method of Controlling Operation Mode of Hybrid Access Terminal Supporting Voice Service and Packet Data Service” filed in the Korean Intellectual Property Office on Jun. 29, 2002 and assigned Ser. No. 2002-37478, the contents of which are incorporated herein by reference.

### BACKGROUND OF THE INVENTION

1. Field of the Invention

The present invention relates generally to a mobile terminal, and in particular, to a method of controlling the operation mode of a hybrid access terminal (HAT) supporting both voice service and high-speed packet data service.

2. Description of the Related Art

3rd generation (3G) wireless communication systems include CDMA (Code Division Multiple Access) 2000 1x, WCDMA/UMTS (Wideband CDMA)/(Universal Mobile Telecommunication System), and GPRS (General Packet Radio System). These 3G wireless communication systems support packet data service such as moving pictures, as compared to 2G wireless communication systems that support voice service only.

A mobile communication system is usually comprised of a mobile station (MS) and a base station (BS) that communicates with the MS on a radio channel. The MS and the BS are designed to meet the radio communication standards of the system. Especially, a HAT is designed to satisfy the radio standards of CDMA 2000 1x supporting voice service and low-speed data service (IS-2000) and of 1xEV-DO (Evolution-Data Only) supporting high-speed packet data service (IS-856).

FIG. 1 illustrates the operation modes of a HAT in conventional 3G wireless communication system. Referring to FIG. 1, upon power on, the HAT receives an overhead message on a paging channel (PCH) in CDMA 2000 1x for initial acquisition. When the initial acquisition is completed, the HAT enters into an IS-2000 only slotted operation mode 10 and monitors its assigned slots of the 1x PCH. The slotted operation refers to a technique in which a mobile terminal wakes up and demodulates channel signals in assigned slots of an overhead channel, while it sleeps in the other slots. This technique reduces the power consumption of communication circuits.

When it acquires a 1xEV-DO system, the HAT performs the slotted operation for both CDMA 2000 1x and 1xEV-DO systems. The HAT is said to be in a hybrid operation mode 13. Thus, the hybrid operation mode 13 is an IS-856 and IS-2000 slotted operation mode. In this mode, the HAT

(1) initially acquires only the CDMA 2000 1x system;

(2) acquires the collocated 1xEV-DO system only after entering a slotted mode in the CDMA 2000 1x system;

(3) scans the CDMA 2000 1x system every 3 minutes after a 15-minute deep sleep if the acquisition of CDMA 2000 1x system is failed;

(4) discontinues the slotted operation in the 1xEV-DO system after the CDMA 2000 1x system acquisition failure and the deep sleep;

(5) enters a 1xEV-DO deep sleep state, maintaining a 1x PCH if the 1x EV-DO system is lost after the two systems are acquired; and

(6) does not attempt to acquire the 1x EV-DO system for 20 minutes if the 1xEV-DO system is acquired but a session is not opened.

Referring again to FIG. 1, to terminate or originate a voice call in the hybrid operation mode 13, the HAT establishes an IS-2000 call and transitions to an IS-2000 connection mode 11 (c). Alternatively, to terminate or originate a packet call, the HAT establishes an IS-856 packet call and transitions to an IS-856 connection mode 12 (e). During the IS-856 packet call, the HAT continues the slotted operation in the CDMA 2000 1x system.

If the HAT fails to acquire the 1xEV-DO system in the IS-2000-only slotted operation mode 10, it attempts to acquire the 1xEV-DO system, continuing the IS-2000-only slotted operation mode 10. To terminate or originate a voice call in this state, the HAT establishes an IS-2000 call and transitions to the IS-2000 connection mode 11(a). To terminate or originate a packet call in the same state, the HAT establishes the IS-2000 packet call or an IS-856 packet call and transitions to the IS-2000 connection mode 11 or the IS-856 connection mode 12(a or d).

Upon release of the voice or packet call in the IS-2000 connection mode 11, the HAT transitions to the IS-2000 only slotted operation mode 10(b). Upon release of the packet call in the IS-856 connection mode 12, the HAT transitions to the previous mode, that is, the hybrid operation mode 13 or the IS-2000 only slotted operation mode 10(f).

As described above, the HAT operates in the hybrid operation mode irrespective of a packet call or a voice call. Thus, both the 1x PCH and the 1xEV-DO control channel (CC) are monitored periodically. As a result, even when the HAT aims at a packet call connection, it must unnecessarily monitor the 1x PCH.

### SUMMARY OF THE INVENTION

It is, therefore, an object of the present invention to provide a method of operating a HAT supporting both CDMA 2000 1x and 1xEV-DO systems in a data-only operation mode.

It is another object of the present invention to provide a method of transitioning a HAT directly to a data-only operation mode without accessing a CDMA 2000 1x system.

It is a further object of the present invention to provide a method of enabling a HAT to receive a voice call and a short message in a CDMA 2000 1x system in a data-only operation mode.

The above objects and others are achieved by a method of controlling the operation mode of a HAT capable of communicating a first communication system that supports voice service and low-speed data service and a second communication system that supports high-speed data service. According to one aspect of the present invention, the HAT monitors both the first and second communication systems in a hybrid operation mode by the HAT. Upon receipt of a message ordering mode transition from the second communication system, the HAT transitions from the hybrid operation mode to a data-only operation mode, discontinues monitoring the first communication system, and monitors only the second communication system.

According to another aspect of the present invention, the HAT monitors both the first and second communication systems in a hybrid operation mode. Upon receipt of a message ordering mode transition from the second communication system, the HAT transitions from the hybrid operation mode to a data-only operation mode, discontinues monitoring the first communication system, and monitors only the second communication system. The HAT reports the transition to the data-only operation mode to the second communication system.

According a further aspect of the present invention, in a method of communication with the HAT, the first communication system determines, upon generation of a signaling message for the HAT, whether the HAT is in a first operation mode monitoring the first communication system or in a second operation mode monitoring the second communication system. If the HAT is in the second operation mode, the first communication system transmits the signaling message to the second communication system. The second communication system wraps the signaling message in a signaling message format of the second communication system, and transmits the wrapped signaling message to the HAT.

According to still another aspect of the present invention, in method of receiving a signaling message from the first communication system during monitoring the second communication system, the HAT receives from the second communication system a signaling message of the first communication system which is wrapped in a signaling message format of the second communication system, and processes the signaling message.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the operation modes of a HAT in conventional 3G wireless communication systems;

FIG. 2 illustrates a CDMA 2000 1x system, a 1xEV-DO system, and a HAT that accesses these systems;

FIG. 3 illustrates the operation modes of a HAT according to an embodiment of the present invention;

FIG. 4 illustrates the format of a Mode Change Request message;

FIG. 5 illustrates the values of a Mode Indication field illustrated in FIG. 4;

FIG. 6 illustrates the format of a Mode Change Complete message;

FIG. 7 illustrates the format of a Quick Config message;

FIG. 8 illustrates the format of a Route Update message;

FIG. 9 illustrates the format of a Wrapped Data message;

FIG. 10 illustrates the values of a Data Type field illustrated in FIG. 9;

FIG. 11 illustrates the values of a Data Channel Type field illustrated in FIG. 9;

FIG. 12 is a block diagram depicting an operation for processing signaling messages in the HAT in a data-only operation mode;

FIG. 13 is a diagram illustrating a signal flow for controlling the operation mode of the HAT in the 1xEV-DO system according to an embodiment of the present invention;

FIG. 14 is a diagram illustrating a signal flow for the HAT to change its operation mode according to the embodiment of the present invention;

FIG. 15 is a diagram illustrating a signal flow for the HAT to register its location to the CDMA 2000 1x system in the data-only operation mode according to an embodiment of the present invention;

FIG. 16 is a diagram illustrating a signal flow for the HAT to terminate a voice call in the data-only operation mode according to an embodiment of the present invention; and

FIG. 17 is a diagram illustrating a signal flow for the HAT to receive a short message in the data-only operation mode according to an embodiment of the present invention.

### DETAILED DESCRIPTION OF THE PREFERRED EMBODIMENTS

Various embodiments of the present invention will be described herein below with reference to the accompanying drawings. In the following description, well-known functions or constructions are not described in detail since they would obscure the invention in unnecessary detail.

In accordance with the embodiments of the present invention, a base station system (BSS) commands a mobile terminal to change its operation mode. A HAT, which can communicate with a communication system supporting voice service and low-speed data service and a communication system supporting high-speed data service, responds to paging for voice service in a data-only operation mode.

Hereinafter, the embodiments of the present invention will be described in the context of a HAT that can access a CDMA 2000 1x system (or 1x system) supporting voice service and low-speed data service based on IS-2000 and a 1xEV-DO system supporting high-speed packet data service based on IS-856.

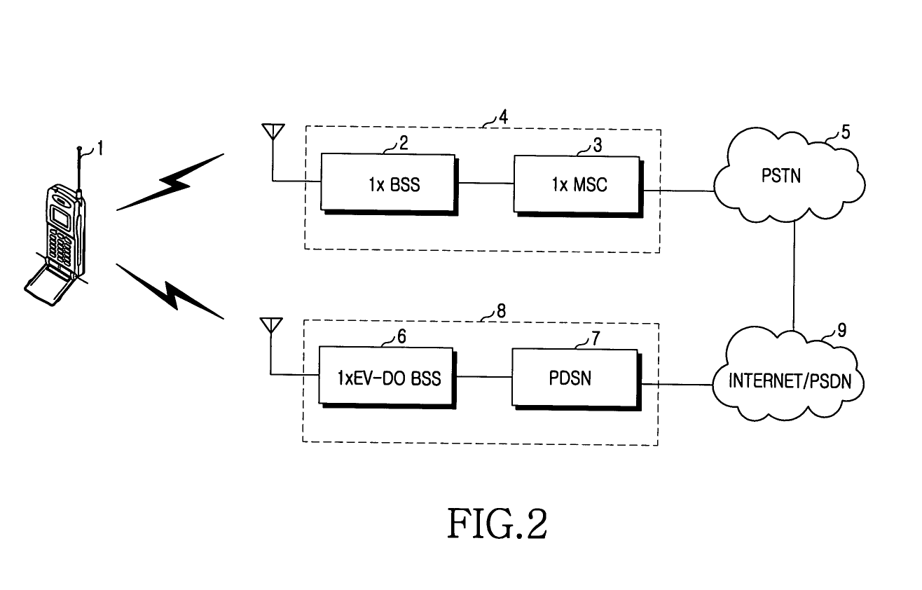

FIG. 2 illustrates the CDMA 2000 1x system, the 1xEV-DO system, and the HAT that accesses these systems. Referring to FIG. 2, the CDMA 2000 1x system 4 is comprised of a 1x BSS 2 supporting IS-2000 interfaces and a 1x MSC (Mobile Switching Center) 3, and is connected to a PSTN (Public Switched Telephone Network) 5. The 1xEV-DO system 8 is comprised of a 1xEV-DO BSS 6 supporting IS-856 interfaces and a PDSN (Packet Data Switching Node) 7, and is connected to an Internet/PSDN (Public Switched Data Network) 9.

The 1x BSS 2 and the 1xEVDO BSS 6 each connect a radio channel to a mobile terminal within their service areas. The HAT 1 communicates with the 1x BSS 2 within the service area of the 1x BSS 2, and with the 1xEV-DO BSS 6 within the service area of the 1xEV-DO BSS 6. When the 1x BSS 2 and the 1xEV-DO BSS 6 are collocated, the HAT 1 communicates with both.

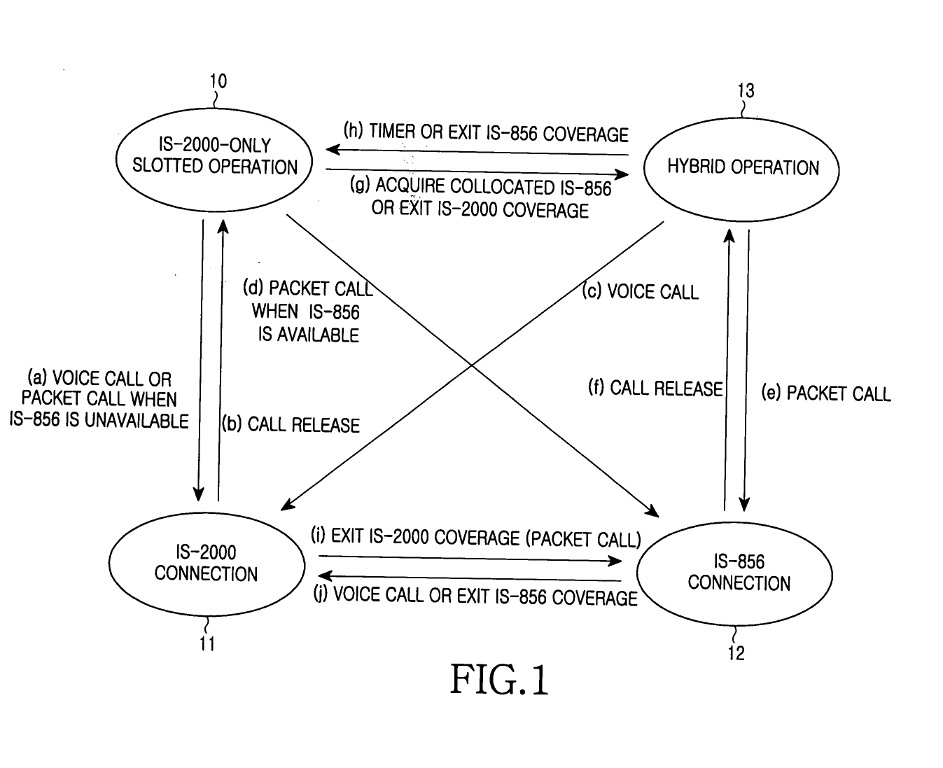

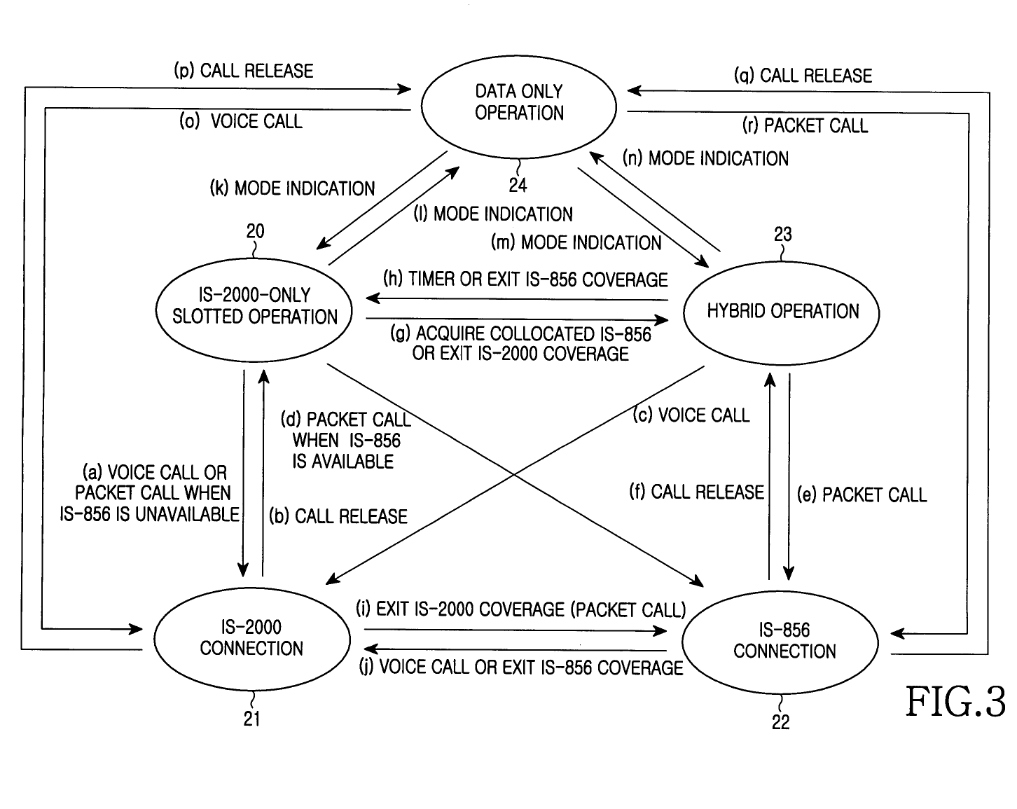

FIG. 3 illustrates the operation modes of the HAT 1 according to the embodiments of the present invention. An IS-856-only slotted mode being a data-only operation mode 24 is further defined in addition to the conventional HAT operation modes illustrated in FIG. 1.

Referring to FIG. 3, the HAT receives an overhead message on a 1x PCH for initial acquisition in an initialization mode. When the initial acquisition is completed, the HAT enters into an IS-2000 only slotted operation mode 20 and monitors its assigned slots of the 1x PCH. If the HAT exits from the coverage area of the CDMA 2000 1x system, or acquires a collocated 1xEV-DO system, it enters a hybrid operation mode 23 or a data-only operation mode 24.

In the hybrid operation mode 23, the HAT performs slotted operations for both CDMA 2000 1x and 1xEV-DO systems. The HAT monitors the assigned 1x PCH slots and assigned 1xEV-DO CC slots. To terminate or originate a voice call in the hybrid operation mode 23, the HAT establishes an IS-2000 call and transitions to an IS-2000 connection mode 21 (c). On the other hand, to terminate or originate a packet call, the HAT establishes an IS-856 packet call and transitions to an IS-856 connection mode 22 (e). During the IS-856 packet call, the HAT continues the slotted operation in the CDMA 2000 1x system.

If the HAT fails to acquire the 1xEV-DO system in the IS-2000 only slotted operation mode 20, it attempts to acquire the 1xEV-DO system periodically, continuing the IS-2000-only slotted operation mode 20. To terminate or originate a voice call in this state, the HAT establishes an IS-2000 call and transitions to the IS-2000 connection mode 21(a). To terminate or originate a packet call in the same state, the HAT establishes the IS-2000 packet call or an IS-856 packet call and transitions to the IS-2000 connection mode 21 or the IS-856 connection mode 22(a or d).

Upon release of the voice or packet call, the HAT transitions to the previous mode. If the HAT establishes the voice call or IS-2000 packet call in the IS-2000-only slotted operation mode 20 and enters into the IS-2000 connection mode 21, and the voice call or packet call is released, the HAT returns to the IS-2000-only slotted operation mode 20(b). If the HAT establishes a packet call in the hybrid operation mode 23 and enters into the IS-856 connection mode 22, and the packet call is released, the HAT returns to the IS-856 connection mode 22(f).

In the data-only operation mode 24, the HAT performs the slotted operation in the 1xEV-DO system. It monitors the assigned CC slots without monitoring the 1x PCH. Therefore, the HAT cannot respond to paging from the CDMA 2000 1x system. This implies that the HAT cannot originate/terminate a voice call or transmit/receive a short message based on IS-2000. To solve this problem, the 1xEV-DO system transmits an overhead message of CDMA 2000 1x on the CC or a forward traffic channel (FTC). When necessary, the HAT can fast tune to the CDMA 2000 1x system.

To terminate or originate a voice call in the data-only operation mode 24, the HAT establishes an IS-2000 call and transitions to the IS-2000 connection mode 21(o). To terminate or originate a packet call, the HAT establishes an IS-856 packet call and transitions to the IS-856 connection mode 22(r). The HAT continues the slotted operation for the CDMA 2000 1x system during the IS-856 connection mode 22.

Upon release of the voice or packet call in the IS-2000 connection mode 21, the HAT transitions to the previous mode, that is, the IS-2000-only slotted operation mode 20 or the data-only operation mode 24(b or p). Upon release of the packet call in the IS-856 connection mode 22, the HAT transitions to the previous mode, that is, the hybrid operation mode 23 or the data-only operation mode 24(f or q).

Messages required to control the operation modes of the HAT are described below.

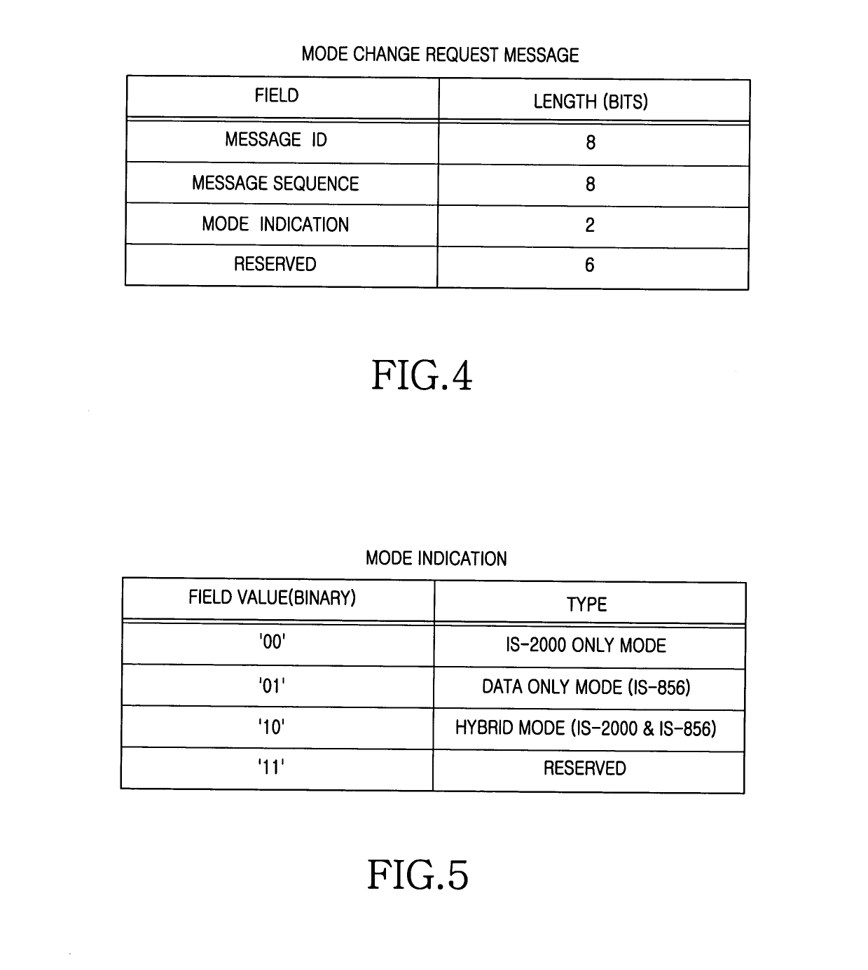

Mode Change Request is a message indicating an operation mode of the HAT and is delivered on the CC or FTC of the 1xEV-DO system. Its format is illustrated in FIG. 4.

Referring to FIG. 4, the Mode Change Request message includes an 8-bit Message ID, an 8-bit Message Sequence, a 2-bit Mode Indication, and a 6-bit reserved field for byte-basis alignment. Message ID is a file identifying a message type. Message Sequence is used to indicate the sequence number of the same message which is repeatedly transmitted, to thereby compensate for transmission errors. Its value is higher than the value of Message Sequence in the previous version of the same message by 1.

Mode Indication indicates an operation mode of the HAT. Its values are defined as illustrated in FIG. 5. As shown in FIG. 5, if Mode Indication is 00, it indicates the IS-2000-only slotted operation mode 20, if Mode Indication is 01, it indicates the data-only operation mode 24, and if Mode Indication is 10, it indicates the hybrid operation mode 23.

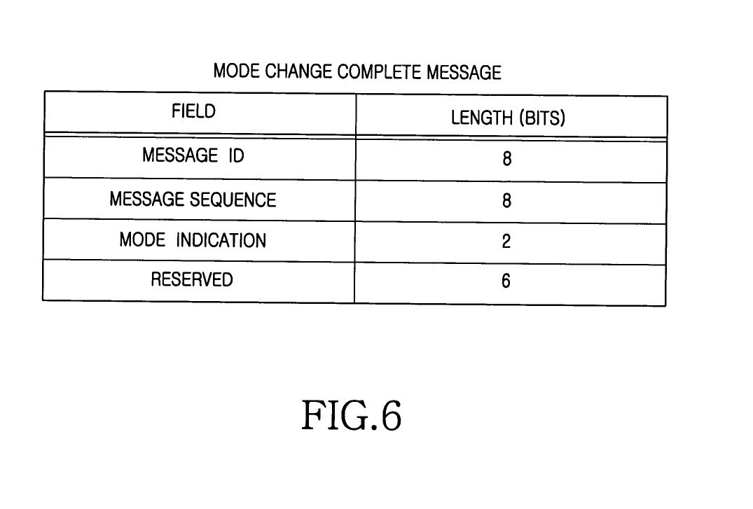

Mode Change Complete is a message by which the HAT reports the result of changing its operation mode in response to the Mode Change Request message. Its format is illustrated in FIG. 6.

Referring to FIG. 6, the Mode Change Complete message is comprised of an 8-bit Message ID, an 8-bit Message Sequence, a 2-bit Mode Indication, and a 6-bit reserved field for byte-basis alignment. The Mode Indication field indicates the current operation mode of the HAT. Its values are defined as illustrated and described above in reference to FIG. 5.

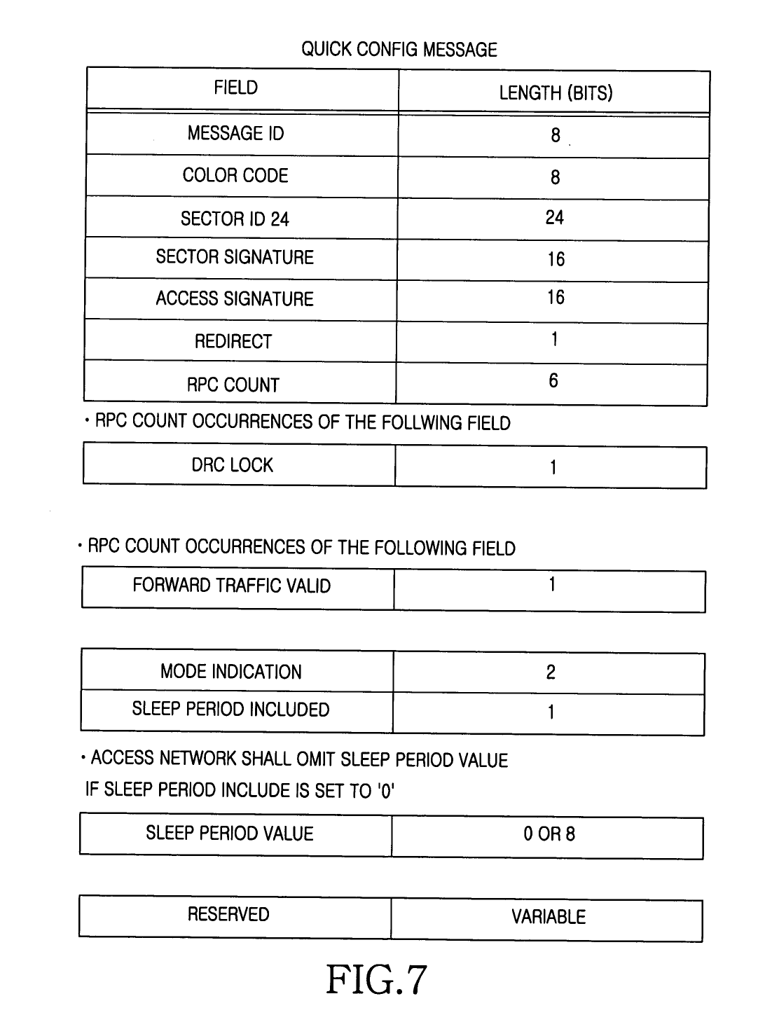

A Quick Config message is a 1xEV-DO overhead message commanding all HATs within the service area of the 1xEV-DO BSS to change their operation modes. This message also controls the sleep mode operation of the HATs. Its format is illustrated in FIG. 7.

Referring to FIG. 7, the Quick Config message includes an 8-bit Message ID, an 8-bit Color code, a 24-bit Sector ID, a 16-bit Sector Signature, a 16-bit Access Signature, a 1-bit Redirect, and an 8-bit RPC Count. The 2-bit Mode Indication is used to change the operation modes of the HATs and a 1-bit Sleep Period Included controls their sleep modes. These two fields are optionally included when an RPC Count occurs.

Mode Indication is a field indicating operation modes of the HATs, as defined in FIG. 5.

If Sleep Period Included is 0, a slot monitoring period is set to 5.12 seconds, as specified in the existing 1xEV-DO standards and Sleep Period Value, which determines a slot monitoring period for the CC, is omitted. If Sleep Period Included is 1, the slot monitoring period can be determined from the relationship 128×2^{SleepPeriodValue}, according to the value of the 8-bit Sleep Period Value.

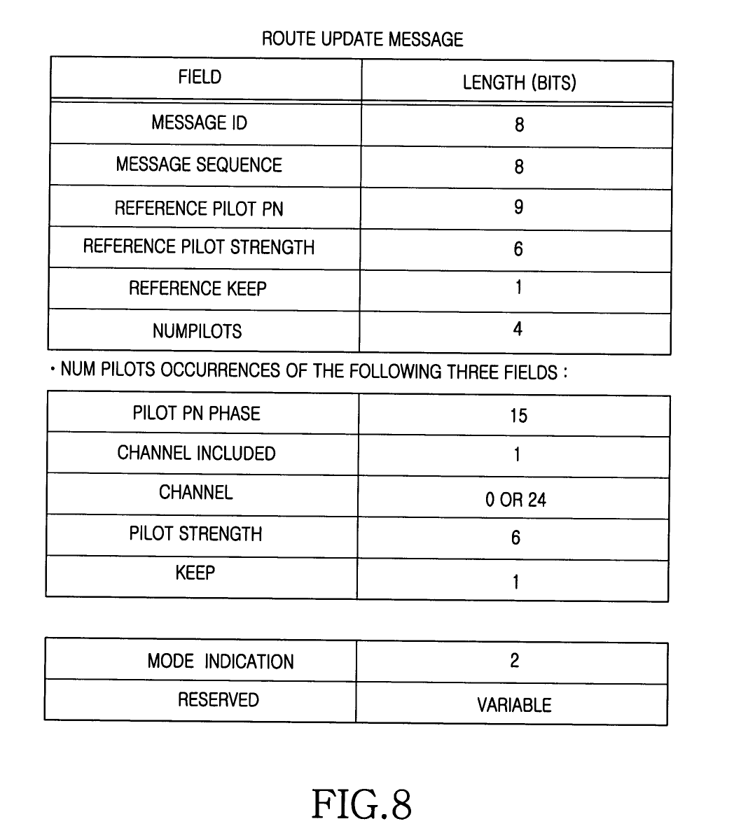

Route Update is a 1xEV-DO location registration message used for the HAT to report an operation mode change if it changes its operation mode by user manipulation. Its format is illustrated in FIG. 8.

Referring to FIG. 8, the Route Update message includes an 8-bit Message ID, an 8-bit Message Sequence, a 9-bit Reference Pilot PN, a 6-bit Reference Pilot Strength, a 1-bit Reference Keep, and a 4-bit NumPilots. Only when NumPilots exists, will 15-bit Pilot PN Phase, 1-bit Channel Included, 24-bit Channel (which is an optional field), 6-bit Pilot Strength, and 1-bit Keep be included in the message. The Route Update message includes the Mode Indication field as defined in FIG. 5.

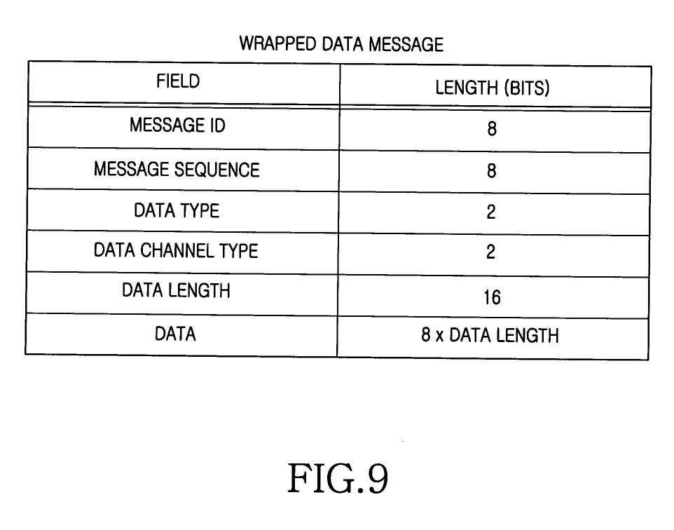

A Wrapped Data message, the format of which is illustrated in FIG. 9, is used for the HAT to communicate the CDMA 2000 1x system through the 1x EV-DO system in the data-only operation mode. It is delivered on the CC or TC of the 1xEV-DO system. That is, a CDMA 2000 1x signaling message is wrapped in a 1xEV-DO overhead and thus becomes a Wrapped Data message. The HAT receives a 1x overhead message including 1x signaling-based system parameters by the Wrapped Data message.

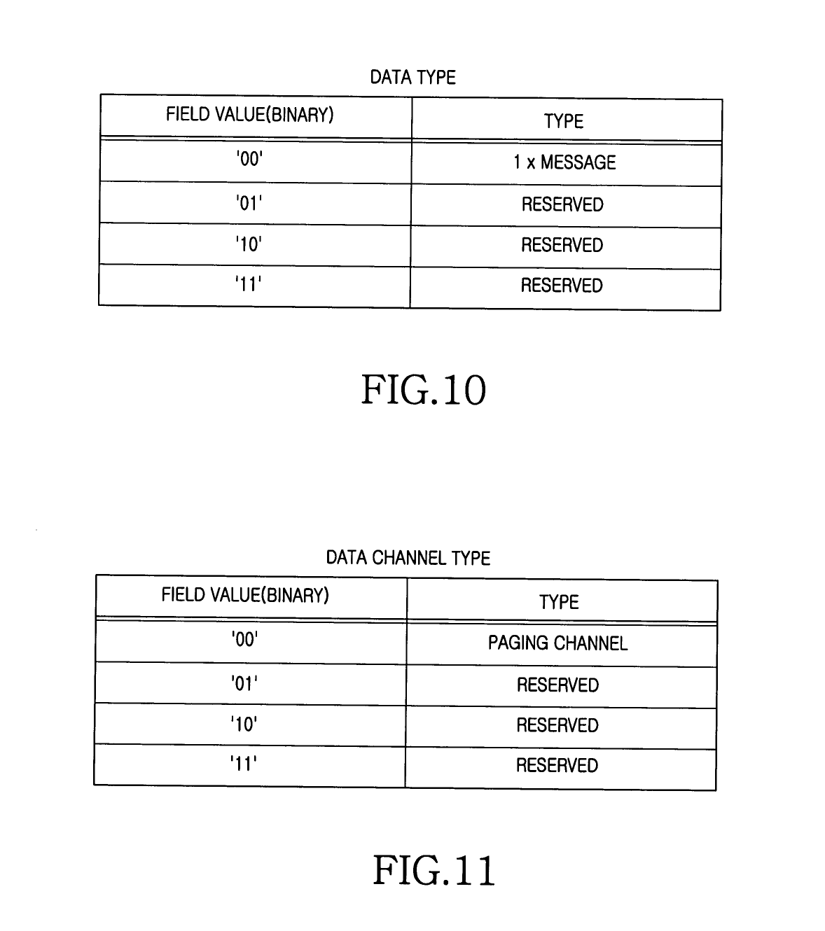

Referring to FIG. 9, the Wrapped Data message includes an 8-bit Message ID, an 8-bit Message Sequence, a 2-bit Data Type, a 2-bit Data Channel Type, a 16-bit Data Length, a 16-bit Data Length, and an 8×Data Length-Data. Data Type indicates the type of a wrapped message and its meaning is illustrated in FIG. 10. If Data Type is 00, it indicates a CDMA 2000 1x signaling message. Data Channel Type is a field indicating a channel that delivers the wrapped message, the meaning of which is illustrated in FIG. 11. If Data Type is 00 and Data Channel Type is 00, a 1x PCH delivers the wrapped message.

Data Length indicates the length of the Data field in bytes. The whole 1x signaling message or its body is filled in the Data field. The body refers to a message body of a Layer 2 format except segmentation in an SAR (Segmentation And Reassembly) sub-layer of IS-2000 Layer 2. It is also called a PDU (Packet Datagram Unit). According to the length of the PDU, the Data field can include one or a plurality of 1x signaling messages.

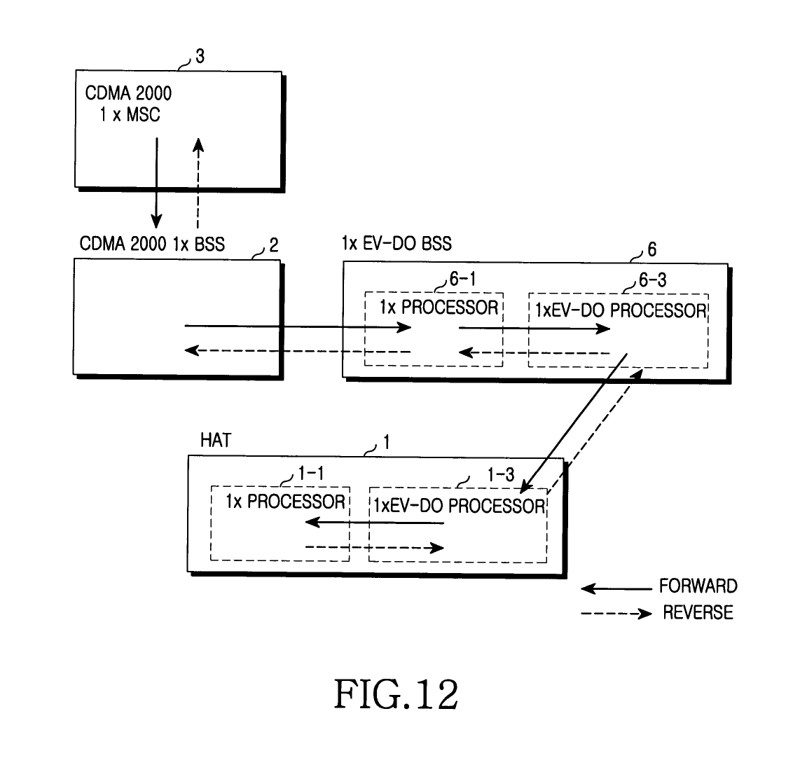

FIG. 12 is a block diagram illustrating a CDMA 2000 1x signaling message process of the HAT in the data-only operation mode. Here, a solid line indicates a forward message flow, and a dotted line indicates a reverse message flow.

Referring to FIG. 12, the 1xEV-DO BSS 6 includes a 1x processor 6-1 for processing CDMA 2000 1x messages and a 1xEV-DO processor 6-3 for processing 1xEV-DO messages. The HAT 1 also includes a 1x processor 1-1 for processing CDMA 2000 1x messages and a 1xEV-DO processor 1-3 for processing 1xEV-DO messages.

When the 1x MSC 3 delivers a forward signaling command to the 1x BSS 2, the 1x BSS 2 generates a corresponding forward signaling message and transmits it to the 1x processor 6-1. The 1xprocessor 6-1 transmits the forward signaling message to the EV-DO processor 6-3. The EV-DO processor 6-3 wraps the forward signaling message in a 1xEV-DO signaling format, thereby generating a Wrapped Data message. The EV-DO processor 6-3 then transmits the Wrapped Data message on a radio channel to the HAT 1 in the data-only operation mode. The 1xEV-DO processor 1-1 of the HAT 1 eliminates the overhead from the Wrapped Data message and transmits the remaining Data field to the 1xprocessor 1-1.

The Wrapped Data message can include every kind of 1x signaling message. This includes, for example, a Page message for termination of a voice call, a Data Burst message for a short message service (SMS), or an overhead message for delivering system parameters.

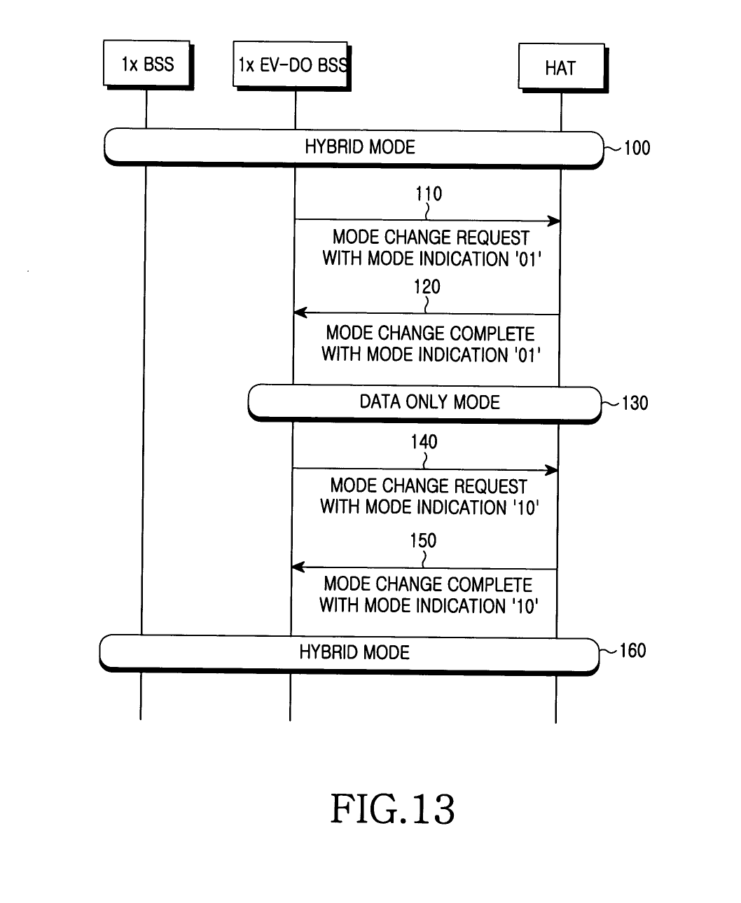

FIG. 13 is a diagram illustrating a signal flow illustrating an operation for controlling the operation modes of the HAT according to an embodiment of the present invention.

Referring to FIG. 13, when the HAT exits from the coverage area of the CDNA 2000 1x system or acquires the collocated 1xEV-DO system, it enters into the hybrid operation mode in step 100. In the hybrid operation mode, the HAT monitors both the 1x PCH and the 1xEV-DO CC.

To transition the HAT to the data-only operation mode, the 1xEV-DO BSS transmits the Mode Change Request message to the HAT on the CC or FTC in order to command transitioning to the data-only operation mode in step 110. The Mode Change Request message is formatted as illustrated in FIG. 4. The Mode Indication field of the message is set to 01 to indicate the data-only operation mode, as illustrated in FIG. 5.

Upon receipt of the Mode Change Request message, the HAT transmits the Mode Change Complete message to the 1xEV-DO BSS on an access channel (AC) or reverse traffic channel (RTC), notifying normal mode change in step 120 and transitions to the data-only operation mode in step 130. Here, Mode Indication is set to 01 in the Mode Change Complete message. In the data-only operation mode, the HAT discontinues monitoring the 1x PCH and performs a slotted operation only for the 1xEV-DO system.

While not shown, the 1xEV-DO BSS may transmit the Quick Config message, ordering all HATs within the 1xEV-DO BSS to transition to the data-only operation mode in step 110. Similarly, Mode Indication is set to 01 in the Quick Config message.

Upon receipt of the Quick Config message, the HAT transitions to the data-only operation mode and performs the slotted operation only for the 1xEV-DO system. In the mode transitioning by the Quick Config message, the HAT does not transmits a response for the message.

If the Hat receives the Mode Change Request message or the Quick Config message in the IS-2000-only slotted operation mode or the hybrid operation mode, it discontinues an ongoing operation for the 1x BSS, transitions to the data-only operation mode, and operates in a slotted mode for the 1xEV-DO BSS.

While not shown in FIG. 3, if the Hat receives the Mode Change Request message or the Quick Config message in the IS-856 connection mode, it simply discontinues a slotted operation for the 1x BSS, maintaining the IS-856 connection mode.

To transition the HAT from the data-only operation mode to the hybrid operation mode, the 1xEV-DO BSS transmits the Mode Change Request message to the HAT on the CC or FTC in step 140. Mode Indication is set to 10 in this case, referring to FIG. 5.

Upon receipt of the Mode Change Request message (or Quick Config message with Mode Indication set to 10), the HAT transmits to the 1xEV-DO BSS the Mode Change Complete message with Mode Indication set to 10 (i.e., hybrid operation mode). The Mode Change Complete message is transmitted on the AC or RTC in step 150, and transitions to the hybrid operation mode in step 160. In the hybrid operation mode, the HAT monitors both the 1x PCH and 1xEV-DO CC.

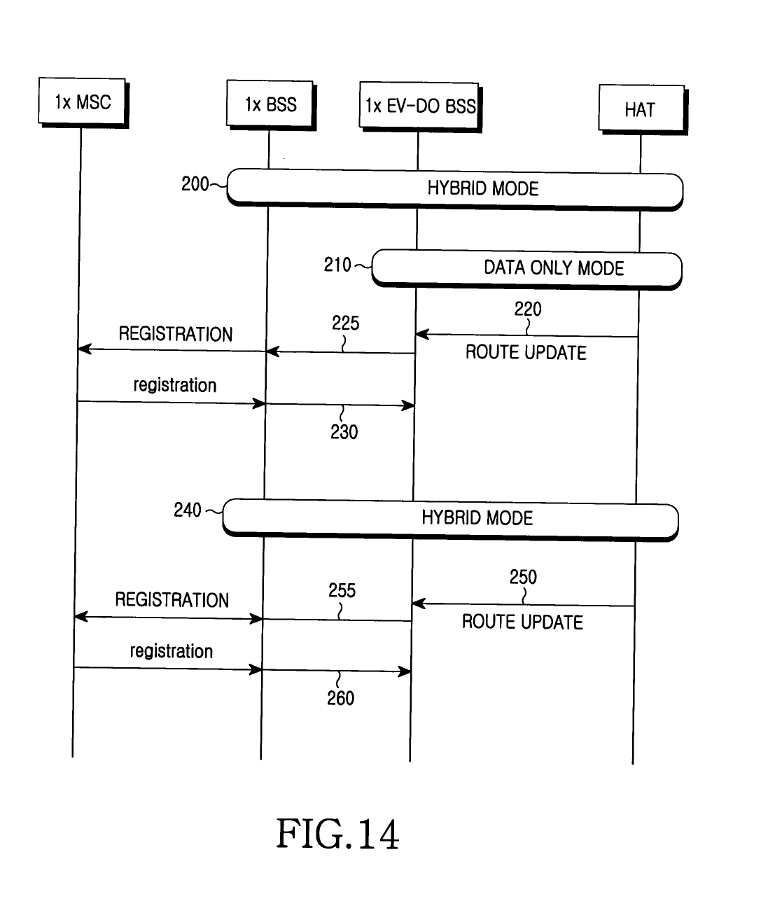

FIG. 14 is a diagram illustrating a message flow for changing its operation mode in the HAT according to an embodiment of the present invention.

Referring to FIG. 14, the HAT monitors both the 1x PCH and 1xEV-DO CC in the hybrid operation mode in step 200. When the HAT is supposed to enter into the data-only operation mode 210 by user manipulation or under a certain condition, it transmits the Route Update message to the 1xEV-DO BSS, for location registration in step 220. The Route Update message is formatted as illustrated in FIG. 5 and includes Mode Indication set to 01.

Each time the HAT registers its location due to mode transition, the 1xEV-DO system transmits the registration information to the 1x system, so that the 1x system can manage the location of the HAT even when the HAT is in the data-only operation mode. Therefore, the 1xEV-DO BSS tells the location of the HAT to the 1x BSS and the 1x BSS transmits a Registration message to the 1x MSC via a 1x interface to request location registration in step 225.

The 1x MSC registers the location of the HAT to an HLR (Home Location Register, which is not shown) and notifies the 1x BSS of the registration result (accept or reject). The 1x BSS, in turn, notifies the 1xEV-DO BSS of the registration result in step 230. The 1xEV-DO BSS does not respond for the Route Update message aiming at location registration only.

If the HAT is to transition from the data-only operation mode to the hybrid operation mode in step 240, it transmits the Route Update message to the 1xEV-DO BSS in step 250. The Route Update message has Mode Indication set to 10 referring to FIG. 5.

In response to the Route Update message, the 1xEV-DO BSS reports the location of the HAT to the 1x BSS. The 1x BSS transmits to the 1x MSC the Registration message requesting location registration via the 1x interface in step 225. The 1x MSC registers the location of the HAT to the HLR and notifies the 1x BSS of the registration result. The 1x BSS in turn notifies the 1xEV-DO BSS of the registration result in step 260. The 1xEV-DO BSS does not respond for the Route Update message aiming at location registration only.

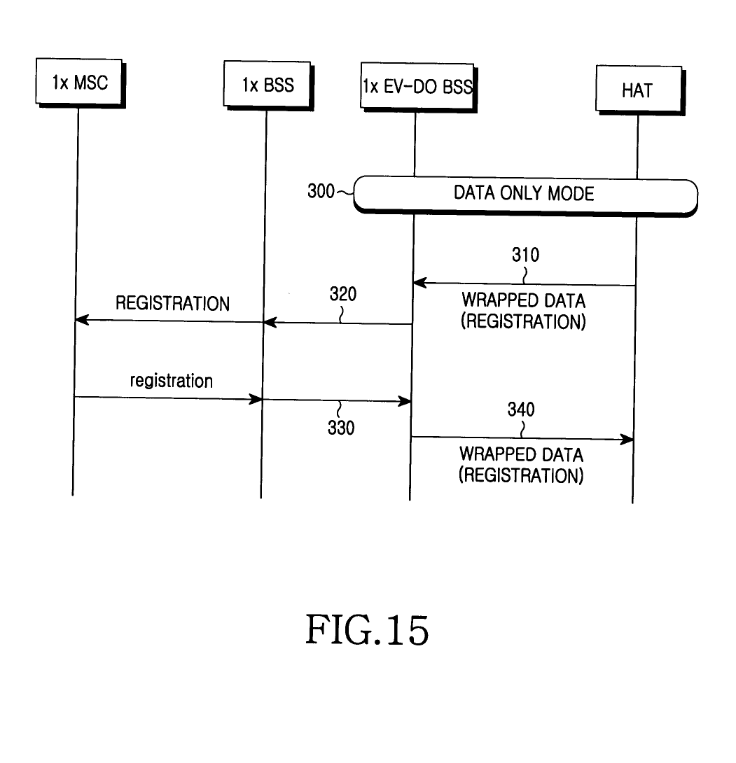

FIG. 15 is a diagram illustrating a message flow for the HAT to register its location to the 1x system in the data-only operation mode according to an embodiment of the present invention.

Referring to FIG. 15, the HAT monitors only the 1xEV-DO CC in the data-only operation mode in step 300. When location registration to the 1x system is required, the HAT transmits to the 1xEV-DO BSS on the AC a Wrapped Data message having the body of a Registration message being a 1x signaling message wrapped in a 1xEV-DO signaling format in step 310. Here, the HAT generates the Registration message body using system parameters set in a 1x signaling overhead message wrapped in a previous Wrapped Data message. The 1xEV-DO BSS generates a Registration message using the Registration message body and delivers it to the 1x MSC via the 1x BSS in step 320.

After registering the location of the HAT to the HLR, the 1x MSC tells the registration result (accept or reject) to the 1xEV-DO BSS by a Registration message in step 330. The 1xEV-DO BSS transmits a Wrapped Data message having the Registration message to the HAT in step 340.

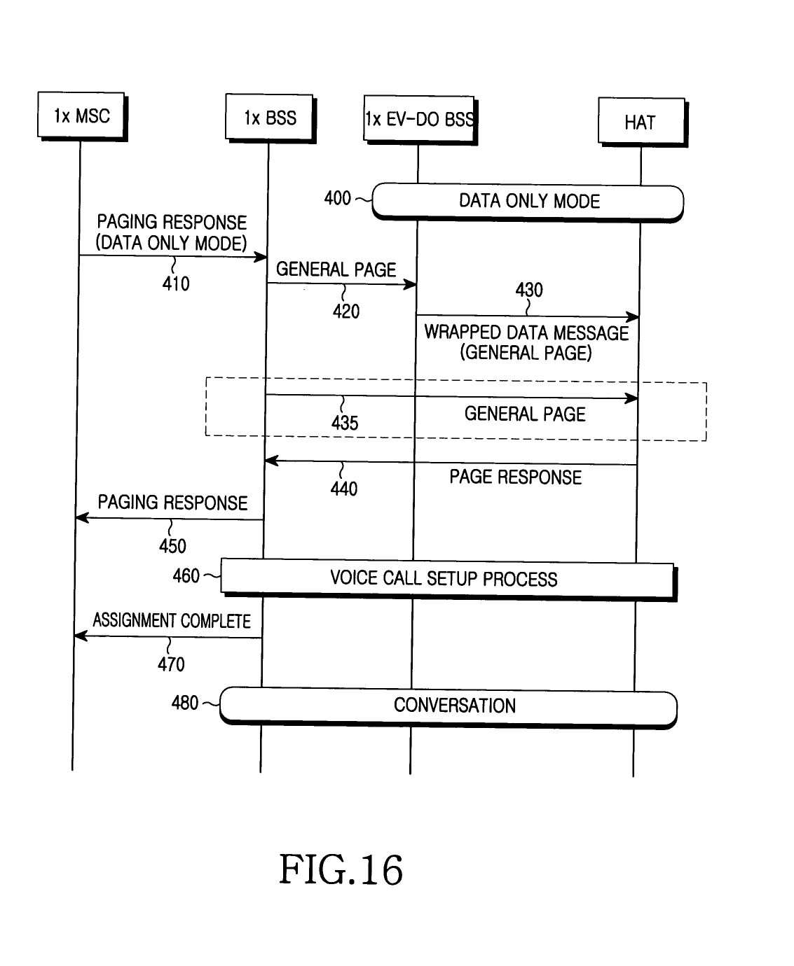

FIG. 16 is a diagram illustrating a signal flow for the HAT to terminate a voice call in the data-only operation mode according to the embodiment of the present invention.

Referring to FIG. 16, the HAT monitors only the 1xEV-DO CC in the data-only operation mode in step 400. Upon request for voice call termination at the HAT, the 1x MSC transmits a Paging Request message to the last 1x BSS to which the HAT has registered its location to page the HAT in step 410. Along with the Page Request message, information indicating that the HAT is currently in the data-only operation mode and information about the 1xEV-DO to which the HAT has tuned are delivered. The 1x BSS then transmits a General Page message to the 1xEV-DO BSS in step 420. The 1xEV-DO BSS transmits to the HAT a Wrapped Data message having the body of the General Page message wrapped in a 1xEV-DO signaling format in step 430. To facilitate paging, the 1xEV-DO BSS may transmit the General Page message directly to the HAT in step 435. Step 435 is optional.

In step 440, the HAT tunes to the 1x system using previously received 1x system parameters and transmits a Page Response message to the 1x BSS. After transmitting the Page Response message to the 1x MSC in step 450, the 1x BSS establishes a voice call by connecting a radio channel to the HAT in step 460 and transmits an Assignment Complete message to the 1x MSC to notify normal voice call setup in step 470. The HAT then conducts the voice call in the IS-2000 connection mode in step 480.

When the voice call is over, the HAT returns to the previous operation mode, that is, the data-only operation mode in this case. If the 1x EV-DO system is unavailable, the HAT returns to the IS-2000-only slotted operation mode.

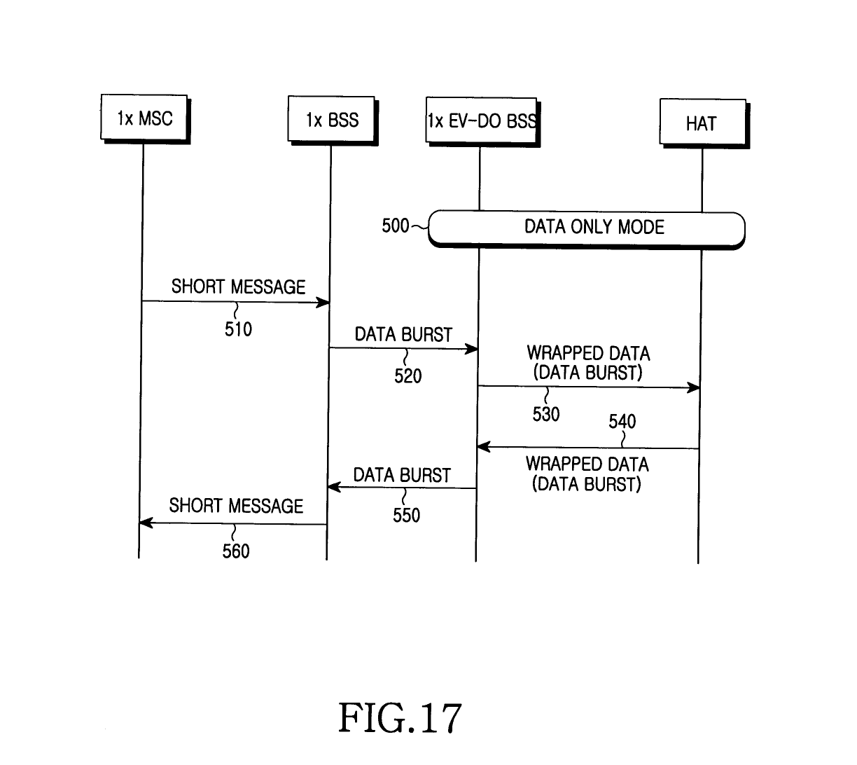

FIG. 17 is a diagram illustrating a message flow for the HAT to receive a short message in the data-only operation mode according to the embodiment of the present invention. It is assumed herein that the short message is received on the 1x PCH. If the short message is received on a 1x traffic channel, the procedure illustrated in FIG. 16 is performed. Also, the 1x MSC is assumed to include a message center that provides the SMS.

Referring to FIG. 17, the HAT monitors only the 1xEV-DO CC in the data-only operation mode in step 500. To transmit a short message, the 1x MSC transmits the short message to the last 1x BSS to which the HAT has registered its location in step 510. The 1x BSS transmits a Data Burst message including the short message to the 1xEV-DO BSS in step 520. The 1xEV-DO BSS transmits to the HAT a Wrapped Data message including the body of the Data Burst message in step 530. The HAT analyzes the Data Burst message body according to 1x signaling and displays the short message on its display.

To transmit a short message in the data-only operation mode, the HAT transmits to the 1xEV-DO BSS a Wrapped Data message having a short message—including Data Burst message wrapped in the 1xEV-DO signaling format in step 540. The 1xEV-DO BSS generates the Data Burst message using the short message in the Wrapped Data message and transmits it to the 1x BSS in step 550. The 1x BSS in turn transmits the Data Burst message to the 1x MSC and the 1x MSC delivers the short message included in the Data Burst message to a corresponding recipient.

In accordance with the embodiments of the present invention as described above, the HAT, operating in the data-only operation mode, does not need to monitor the CDMA 2000 1x system, thereby saving power and increasing data service throughput. Furthermore, the HAT can receive a voice call or a short message in the data-only operation mode.

While certain embodiments of the invention have been shown and described with reference to various embodiments thereof, these are merely examples. For example, while the Wrapped Data message is used to receive a voice call or a short message in the embodiment of the present invention, it is also applicable to transmission/reception of other 1x signaling-based overhead messages. In this case, as many signaling messages as allowed can be wrapped in the Wrapped Data message. Therefore, it will be understood by those skilled in the art that various changes in form and details may be made therein without departing from the spirit and scope of the invention as defined by the appended claims.

What is claimed is:

1. A method of controlling the operation mode of a hybrid access terminal (HAT) capable of communicating a first communication system that supports voice service and low-speed data service and a second communication system that supports high-speed data service, the method comprising the steps of:
monitoring both the first and second communication systems in a hybrid operation mode by the HAT; and
transitioning from the hybrid operation mode to a data-only operation mode, upon receipt of a message ordering mode transition from the second communication system, discontinuing monitoring the first communication system, and monitoring only the second communication system by the HAT.

2. The method of claim 1, further comprising the steps of:
wrapping a signaling message from the first communication system in a signaling message format of the second communication system and transmitting the wrapped signaling message to the HAT in the data-only operation mode by the second communication system; and
processing the wrapped signaling message in the HAT.

3. The method of claim 3, wherein the signaling message is an overhead message including system parameters of the first communication system.

4. The method of claim 1, further comprising the steps of:
wrapping a paging message for voice call termination from the first communication system in the signaling message format of the second communication system and transmitting the wrapped paging message to the HAT in the data-only operation mode by the second communication system;
tuning to the first communication system according to the system parameters of the first communication system, transitioning to a voice call connection mode, and establishing a voice call by the HAT; and
transitioning from the voice call connection mode to the data-only operation mode by the HAT, upon release of the voice call.

5. The method of claim 1, further comprising the steps of:
wrapping a data burst message for transmission of a short message from the first communication system in the signaling message format of the second communication system and transmitting the wrapped data burst message to the HAT in the data-only operation mode by the second communication system; and
extracting the short message from the wrapped data burst message and displaying the short message by the HAT.

6. The method of claim 1, further comprising the step of:
wrapping a signaling message destined for the first communication system in the signaling message format of the second communication system and transmitting the wrapped signaling message to the second communication system by the HAT.

7. The method of claim 1, further comprising the step of:
wrapping a location registration message for registering the location of the HAT to the first communication system in the signaling message format of the second communication system and transmitting the wrapped location registration message to the second communication system by the HAT.

8. The method of claim 1, further comprising the step of:
wrapping a short message in the signaling message format of the second communication system and transmitting the wrapped short message to the second communication system by the HAT.

9. The method of claim 1, wherein the first communication system is a CDMA 2000 1x system and the second communication system is a 1xEV-DO system.

10. A method of controlling the operation mode of a hybrid access terminal (HAT) capable of communicating a first communication system that supports voice service and low-speed data service and a second communication system that supports high-speed data service, the method comprising the steps of:
monitoring both the first and second communication systems in a hybrid operation mode by the HAT;
transitioning from the hybrid operation mode to a data-only operation mode, upon receipt of a message ordering mode transition from the second communication system, discontinuing monitoring the first communication system, and monitoring only the second communication system by the HAT; and
reporting the transition to the data-only operation mode to the second communication system by the HAT.

11. The method of claim 10, wherein the first communication system is a CDMA 2000 1x system and the second communication system is a 1xEV-DO system.

12. A method of communication with a hybrid access terminal (HAT) capable of communicating a first communication system that supports voice service and low-speed data service and a second communication system that supports high-speed data service, the method comprising the steps of:
determining, upon generation of a signaling message for the HAT, whether the HAT is in a first operation mode monitoring the first communication system or in a second operation mode monitoring the second communication system by the first communication system;
transmitting the signaling message to the second communication system by the first communication system, if the HAT is in the second operation mode; and
wrapping the signaling message in a signaling message format of the second communication system and transmitting the wrapped signaling message to the HAT by the second communication system.

13. The method of claim 12, further comprising the step of:
transmitting the signaling message to the HAT by the first communication system, if the HAT is in the first operation mode.

14. The method of claim 12, wherein the signaling message is a paging message for voice call termination from the first communication system, or a data burst message for transmitting a short message from the first communication system.

15. The method of claim 12, wherein the first communication system is a CDMA 2000 1x system and the second communication system is a 1xEV-DO system.

16. A method of receiving a signaling message from a first communication system that supports voice service and low-speed data service during monitoring a second communication system that supports high-speed data service in a hybrid access terminal (HAT) capable of communicating the first communication system and the second communication system, the method comprising the steps of:
receiving from the second communication system a signaling message of the first communication system which is wrapped in a signaling message format of the second communication system; and
processing the signaling message.

17. The method of claim 16, further comprising the step of:
tuning to the first communication system according to system parameters of the first communication system and establishing a voice call, if the signaling message is a paging message for voice call termination from the first communication system.

18. The method of claim 16, further comprising the step of:
extracting a short message from a data burst message and displaying the short message, if the signaling message is the data burst message for transmitting the short message from the first communication system.

19. The method of claim 16, wherein the first communication system is a CDMA 2000 1x system and the second communication system is a 1xEV-DO system.
